(19) United States
(12) Patent Application Publication
(10) Pub. No.: US 2005/0189889 A1
(43) Pub. Date: Sep. 1, 2005

(54) Modular control system for an AC motor

(76) Inventors: John M. Wirtz, Arden, NC (US); Paul J. Siebenlist, Hartfold, WI (US); James E. Armes, Kenosha, WI (US); Rick E. Schnur, Pewaukee, WI (US)

Correspondence Address: PETER C. STOMMA;BOYLE, FREDRICKSON, NEWHOLM,, STEIN & GRATZ, S.C., 250 East Wisconsin Avenue, Suite 1030, Milwaukee, WI, 53202, US

(21) Appl. No.: 10/789,652

(22) Filed: Feb. 27, 2004

(51) Int. Cl. H02P 1/54

(52) U.S. Cl. 318/105

(57) ABSTRACT

A modular control system for an AC motor is provided. The modular control system includes a drive module, a control module, and an intermediate module therebetween. The drive module houses an AC drive that interconnects an AC motor to a utility power source. Control structure for controlling operation of the AC drive is provided in the control module. The control structure and the control module and AC drive in the drive module are electrically coupled through the intermediate module.

### FIELD OF THE INVENTION

This invention relates generally to drives for controlling operation of AC motors, and in particular, to a modular control system incorporating a drive to control operation of an AC motor.

### BACKGROUND AND SUMMARY OF THE INVENTION

As is known, conventional AC drive systems convert three-phase, 60 hertz input power to an adjustable frequency and voltage source for controlling the speed of an AC motor. Typically, these drive systems are large, complicated devices that incorporate a drive unit and a bypass unit in a single enclosure. The bypass unit is provided in order to maintain electrical power to the AC motor in the event that the drive unit fails. However, while most prior bypass units are designed for redundancy, the redundancy of these prior bypass units is limited. By way of example, for electronic based bypass units, communication and controls are lost when the incoming utility power to the AC drive system is lost. Consequently, it can be appreciated that a more redundant AC drive system than present systems is highly desirable.

In addition, due to the complicated nature of present AC drive systems, large amounts of engineering time may be required to incorporate these AC drive systems into new or different applications and environments. For the user, a complicated AC drive system translates into complicated set up procedures. For example, due to the complexity and large footprint of these prior AC drive systems, it may be difficult to interconnect such AC drive systems in certain environments since all of the structural components of these prior AC drive systems are arranged in a single enclosure.

In order to overcome the limitations of these prior art drive systems, AC drive systems have been developed that separate the AC drive system into component parts in order to simplify set up of the AC drive system in various applications and environments. By way of example, Miettinen et al., U.S. Pat. No. 6,385,069 discloses an AC drive system formed from a power part and a control and adjustment part. The power part includes a means for converting alternating current into direct current and again to alternating current having an adjustable frequency. The control and adjustment part includes a means for controlling and adjusting the operation of the power part. The control and adjustment part and the power part are interconnected by a telecommunications connection.

While functional in certain applications, the AC drive system disclosed in the '069 patent is limited. For example, the AC drive system disclosed in the '069 patent does not incorporate a bypass component. As a result, the bypass component must take the form of a separate bypass unit. This, in turn, may complicate the installation procedure. Further, installation in the field of a bypass unit for a previously installed AC drive unit often requires remounting of the AC drive unit thereby increasing the overall cost to an end user. It is noted that control of the bypass unit is still dependent upon the electrical power supplied to the AC drive unit and still requires a secondary set of mechanical switches and/or a second keypad to program the control of the bypass unit. It can be appreciated that the use of separate power and bypass units increases the overall footprint of the AC drive system, making such a system difficult or uneconomical to install in various environments.

Therefore, it is a primary object and feature of the present invention to provide a modular control system for an AC motor that may be simply and easily installed in various environments.

It is a further object and feature of the present invention to provide a modular control system for an AC motor that has a smaller footprint than prior AC drives systems.

It is a still further object and feature of the present invention to provide a modular control system for an AC motor that incorporates an AC drive and that is field upgradeable without the remounting of the AC drive.

In accordance with the present invention, a modular control system for an AC motor is provided. The modular control system includes a drive module housing an AC drive. The AC drive interconnects the AC motor to a utility power source. A control module houses a control structure for controlling operation of the AC drive. An intermediate module interconnects the control module and the drive module so as to electrically couple the control structure and the AC drive.

The control structure includes a control circuit operatively connected to the AC drive and a user interface for allowing the user to program the control circuit. The intermediate module may house a bypass circuit for interconnecting the AC motor to the utility power source in response to failure to the AC drive. The control circuit may be also connected to the bypass circuit for controlling the same. Alternatively, the intermediate module may house a disconnect circuit that interconnects the AC drive to the utility power source. The disconnect circuit disconnects the AC drive from the AC power source in response to a user selected condition on the AC motor.

The modular control system may also include a power module that is selectively connectable to the control structure. The power module includes a secondary power source for supplying electrical power to the control structure independent of the utility power source.

In accordance with a further aspect of the present invention, a drive system is provided for an AC motor. The drive system includes a power unit housing an AC drive. The AC drive is connectable to the AC motor and to a power source. The drive system also includes an interface unit and an intermediate unit. The interface unit houses a programmable control circuit that controls operation of the AC drive. The intermediate unit is disposed between and interconnects the power unit and the interface unit.

The power unit includes a housing having an interior for receiving the AC drive therein. The AC drive has an input connectable to a power source and an output connectable to the AC motor. The interface unit includes a housing having an interior for receiving a control circuit and a user interface for allowing a user to program the control circuit. The user interface may include a keypad and a display.

The intermediate unit of the drive system includes a housing having an interior. Such housing encloses a bypass circuit and/or a disconnect circuit. The bypass circuit is connected in parallel with the AC drive and interconnects the AC motor to the power source in response to failure of the AC drive. It is contemplated for the control circuit to be operatively connected to the bypass circuit so as to allow the control circuit to control operation of the bypass circuit. Alternatively, the disconnect circuit received within the interior of the housing may be connected in series with the AC drive. The disconnect circuit disconnects the AC drive from the power source in response to a predetermined condition. The drive system may also include a power supply unit having a power supply connectable to the control circuit for providing electrical power to the control circuit independent of the power source.

In accordance with a still further aspect of the present invention, a drive system is provided for an AC motor. The drive system includes a power module housing an AC drive. The AC drive is connectable to an AC motor and to a power source. An interface module houses a programmable circuit that controls operation of the AC drive. The drive system may also include a power supply unit having a power supply selectively connectable to the control circuit for providing electrical power to the control circuit independent of the power source.

The power module may include a housing having an interior for receiving an AC drive therein. The AC drive has an input connectable to a power source and an output connectable to the AC motor. The interface module includes a housing having an interior for receiving the control circuit and a user interface for allowing the user to program the control circuit. An intermediate module my be disposed between and interconnect the power module and the interface module. The intermediate module includes a housing having an interior for receiving a bypass circuit therein. The bypass circuit is connected in parallel with the AC drive in order to interconnect the AC motor to the power source in response to failure of the AC motor drive.

In addition, the housing of the intermediate module may receive a disconnect circuit that is connectable in series with the AC drive. The disconnect circuit disconnects the AC drive from the power source in response to a predetermined condition. It is contemplated for the control circuit to be operatively connected to the bypass circuit to control operation thereof.

### BRIEF DESCRIPTION OF THE DRAWINGS

The drawings furnished herewith illustrate a preferred construction of the present invention in which the above advantages and features are clearly disclosed as well as others which will be readily understood from the following description of the illustrated embodiment.

In the drawings:

FIG. 1 is an isometric view of a modular drive system in accordance with the present invention;

FIG. 2 is an exploded, isometric view of the modular drive system in accordance with the present invention; and

FIG. 3 is a schematic view of the modular drive system of the present invention incorporating a bypass circuit within an intermediate module thereof.

### DETAILED DESCRIPTION OF THE INVENTION

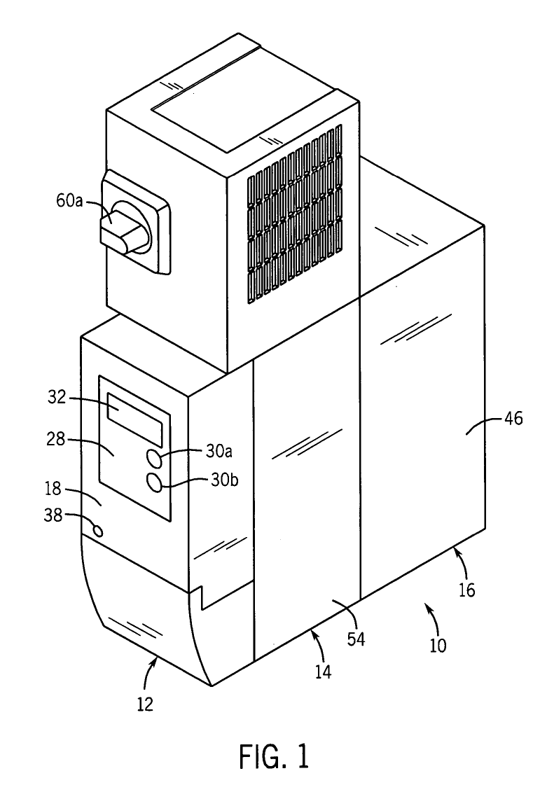

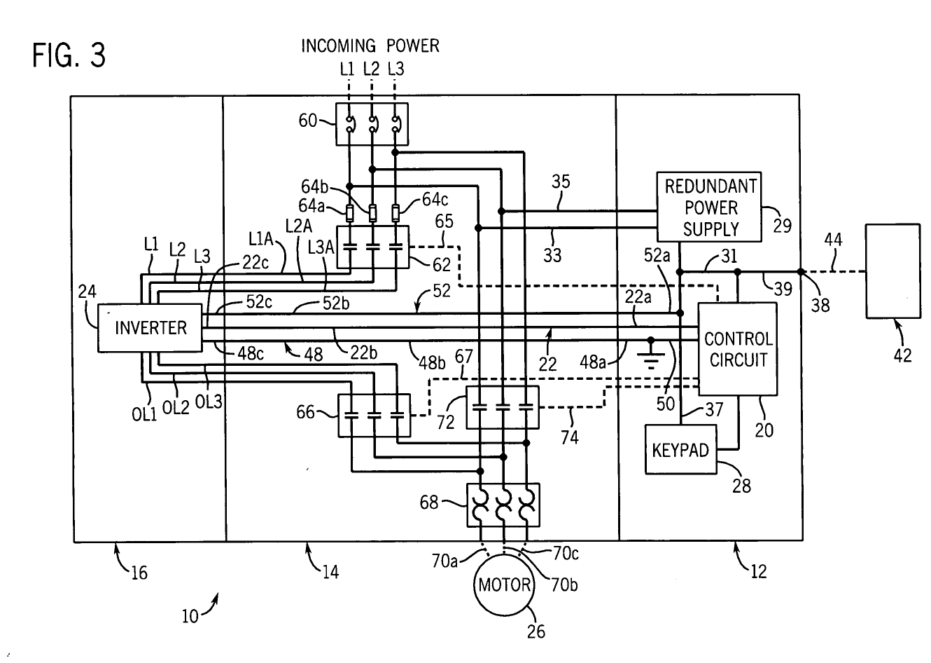

Referring to FIGS. 1-3, a modular control system in accordance with the present invention is generally designated by the reference numeral 10. Control system 10 includes interface module 12, intermediate module 14 and drive module 16 physically connected in any suitable manner such as by screws or the like. It can be appreciated that additional modules may be positioned between the interface module 12 and drive module 16 without deviating from the scope of the present invention.

Interface module 12 includes housing 18 that receives control circuit 20 therein. Control circuit 20 incorporates a central processing unit (CPU) that generates switching signals on lines 22 for inverter 24. As is conventional, inverter 24 converts three-phase, 60 hertz input power to an adjustable frequency and voltage source for controlling the speed of AC motor 26. The switching signals provided by the CPU of control circuit 20 adjust the voltage and the frequency of the energization signals supplied by inverter 24 to AC motor 26. Control circuit 20 is also connected to redundant power supply 29 through line 31. Redundant power supply 29 is received within housing 18 of interface module 10 and is interconnected to incoming power lines L1 and L2 by lines 33 and 35, respectively. Redundant power supply 29 converts the AC voltage across incoming power lines L1 and L2 to a constant DC voltage (e.g., 24 volts) for energizing control circuit 20. It is noted that redundant power supply 29 may be positioned within intermediate module 14 without deviating from the scope of the present invention.

Interface module 12 further includes keypad 28 received within housing 18. Keypad 28 is powered by redundant power supply 29 through line 37 and is operatively connected to control circuit 20. Keypad 28 includes a plurality of pushbuttons 30a and 30b that allow a user to program control circuit 20. It is contemplated for keypad 28 to further include a visual display 32 to facilitate the programming of control circuit 20 and to allow a user to monitor conditions on AC motor 26 as hereinafter described.

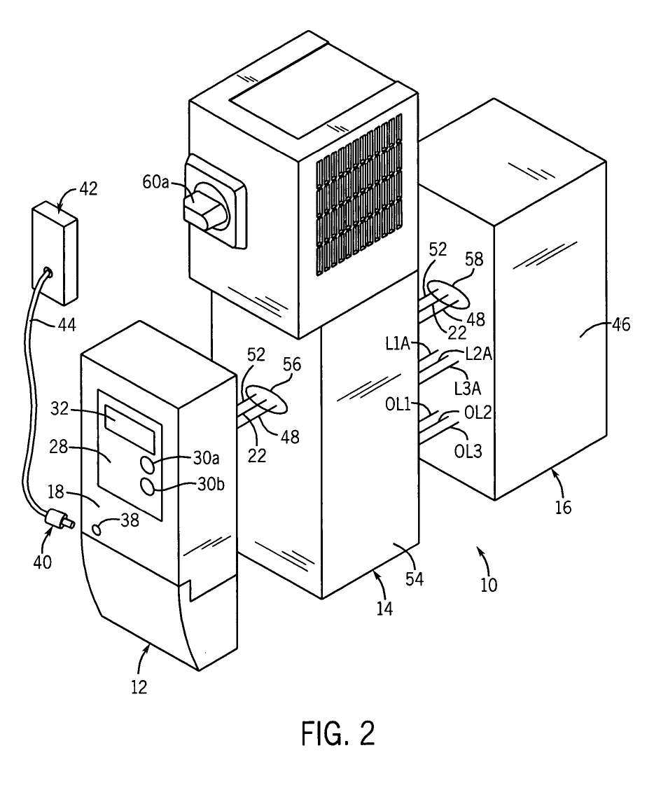

In the event of a power outage across incoming power on incoming power lines L1 and L2 or a lack of power being supplied to control system 10, interface module 12 further includes a secondary power input 38 that is interconnected to line 31 by line 39. As best seen in FIG. 2, secondary power input 38 is adapted to receive a conventional plug 40 interconnected to secondary DC power source 42 by line 44. In the event of power outage across power lines L1 and L2, a user may interconnect plug 40 of secondary DC power source 42 into secondary power input 38 in intermediate housing 18 in order to supply electrical power to control circuit 20 and keypad 28. As a result, control circuit 20 may be programmed by keypad 28 prior to interconnecting incoming power lines L1-L3 to a utility power source.

Drive module 16 includes housing 46 for receiving inverter 24. Inverter 24 operatively connects motor 26 to the incoming utility power, as hereinafter described. Inverter 24 is also connected to control circuit 20 by line 22 and to the output of redundant power supply 29 by line 52. In addition, inverter 24 and control circuit 20 are connected to ground by lines 48 and 50, respectively. It can be appreciated that lines 22, 48 and 52 extend between interface module 12 and drive module 16 and include first portions 22a, 48a and 52a in housing 18 of interface module 12, second portions 22b, 48b and 52b within housing 54 of intermediate module 14, and third portions 22c, 48c and 52c within housing 46 of drive module 16.

First portions 22a, 48a and 52a of lines 22, 48 and 52, respectively, are interconnected to corresponding second portions 22b, 48b and 52b of lines 22, 48 and 52, respectively, by connector 56. In addition, second portions 22b, 48b and 52b of lines 22, 48 and 52, respectively, are interconnected to corresponding third portions 22c, 48c, and 52c of lines 22, 48 and 52, respectively, by connector 58.

Intermediate module 14 includes circuit breaker 60 provided in incoming power lines L1-L3. As is conventional, circuit breaker 60 includes a plurality of resettable fuse-like devices that are designed to protect AC drive system 10 against overloading and switch 60a, FIGS. 1-2, to allow a user to selectively open and close circuit breaker 60. The outputs of circuit breaker 60 may be operatively connected to the inputs of inverter input contactor 62 by corresponding fuses 64a-64c. As is known, fuses 64a-64c protect inverter 24 from excess currents on incoming power lines L1-L3. Inverter input contactor 64 may take the form of normally open mechanical switches that close in response to the presence of electrical power on incoming power lines L1-L3 or in response to instructions received from control circuit 20 on line 65. With its mechanical switches closed, inverter input contactor 62 operatively connects incoming power lines L1-L3 to inverter 24. Through portions L1A, L2A and L3A of incoming power lines L1, L2 and L3, respectively.

In response to the switching signals from control circuit 20, inverter 24 converts the three-phase 60 hertz input power on lines L1-L3 to a desired three-phase output power having an adjustable frequency and voltage on lines OL1-OL3 for controlling the speed of AC motor 26. Output lines OL1-OL3 are interconnected to the inputs of output contactor 66 having normally open mechanical switches. In response to electrical power on output lines OL1-OL3 or in response to instructions received from control circuit 20 on line 67, the mechanical switches of output contactors 66 close so as to electrically connect inverter 24 to the inputs of overload relay 68. The outputs of overload relay 68 are connectable to motor 26 by lines 70a-70c.

As is conventional, overload relay 68 includes a plurality of mechanical switches that open in response to the current flowing therethrough exceeding a predetermined value so as to protect motor 26. The inputs of overload relay 68 are also connected to incoming power lines L1-L3 through bypass contactor 72. In the event of a power outage or failure of inverter 24, the mechanical switches of bypass contactor 72 close so as to interconnect incoming power lines L1-L3 to the inputs of overload relay 62. Consequently, it is contemplated to interconnect control circuit 20 to bypass contactor 72 through line 74. Control circuit 20 may monitor the incoming power on lines L1-L3 and/or the status of inverter 24 through line 22 and close the mechanical switches of the bypass contactor 72 in response to a power outage or a failure of inverter 24. Further, control circuit 20 may be operatively connected to one or more of the lines 70a-70c to motor 26 in order to monitor the operating conditions of motor 26 and report the same on display 32 of keypad 26.

As described, it can be appreciated that modular control system 10 of the present invention allows for a user to simply and easily interconnect control system 10 to a power source and to AC motor 26 in various environments. Further, supplemental power supply 42 allows for the control circuit 20 to be programmed without the presence of incoming electrical power on lines L1-L3. This facilitates the initial set up of modular control system 10 on site, or alternatively, allows for the programming of control circuit 20 prior to installation at the site without regard to the presence of electrical power at such site. This, in turn, makes modular control system 10 easier and quicker for contractors to install. It can be further understood that other types of peripheral devices for use in the control of power incoming to and outgoing from control system 10, as well as, additional components for controlling operation of motor 26 may be housed in intermediate module 14 without deviating from the scope of the present invention.

Various modes of carrying out the invention are contemplated as being within the scope of the following claims particularly pointing out and distinctly claiming the subject matter that is regarded as the invention.

1. A modular control system for an AC motor, comprising:
a drive module housing an AC drive, the AC drive interconnecting the AC motor to a utility power source;
a control module housing a control structure for controlling operation of the AC drive;
a redundant power supply operatively connected to the control structure for supplying electrical power to the control structure; and
an intermediate module interconnecting the control module and the drive module so as to electrically couple the control structure and the AC drive.

2. The modular control system of claim 1 wherein the control structure includes a control circuit operatively connected to the AC drive and a user interface for allowing a user to program the control circuit.

3. The modular control system of claim 2 wherein the intermediate module houses a bypass circuit for interconnecting the AC motor to the utility power source in response to failure of the AC drive.

4. The modular control system of claim 3 wherein the control circuit is operatively connected to the bypass circuit for allowing a user to program the bypass circuit.

5. The modular control system of claim 2 wherein the intermediate module houses a disconnect circuit for interconnecting the AC drive to the utility power source, the disconnect circuit disconnecting the AC drive from the power source in response to a user selected condition on the AC motor.

6. The modular control system of claim 2 wherein the user interface includes a keypad.

7. The modular control system of claim 1 further comprising a power module selectively connectable to the control structure, the power module including a secondary power source for supplying electrical power to the control structure independent of the utility power source.

8. The modular control system of claim 1 wherein the redundant power supply is provided in the control module.

9. A drive system for an AC motor, comprising:
a power unit housing an AC drive, the AC drive connectable to the AC motor and to a power source;
an interface unit housing a programmable control circuit that controls operation of the AC drive;
a redundant power supply operatively connected to the control circuit for supplying electrical power to the control structure; and
an intermediate unit disposed between and interconnecting the power unit and the interface unit.

10. The drive system of claim 9 herein the power unit includes a housing having an interior for receiving the AC drive therein, the AC drive having an input connectable to a power source and an output connectable to the AC motor.

11. The drive system of claim 9 wherein the interface unit includes:
a housing having an interior for receiving the control circuit; and
a user interface for allowing a user to program the control circuit.

12. The drive system of claim 11 herein the user interface includes a keypad and a display.

13. The drive system of claim 9 wherein the intermediate unit includes:
a housing having an interior; and
a bypass circuit received with the interior of the housing and being connected in parallel with the AC drive, the bypass circuit interconnecting the AC motor to the power source in response to failure of the AC drive.

14. The drive system of claim 9 wherein the intermediate unit includes:
a housing having an interior; and
a disconnect circuit received with the interior of the housing and being connected in series with the AC drive, the disconnect circuit disconnecting the AC drive from the power source in response to a predetermined condition.

15. The drive system of claim 9 further comprising a power supply unit having a power supply selectively connectable to the control circuit for providing electrical power to the control circuit independent of the power source.

16. The drive system of claim 9 wherein the redundant power supply is housed in the interface module.

17. A drive system for an AC motor, comprising:
a power module housing an AC drive, the AC drive connectable to the AC motor and to a power source;
an interface module housing a programmable control circuit that controls operation of the AC drive; and
a power supply unit having a power supply selectively connectable to the control circuit for providing electrical power to the control circuit independent of the power source.

18. The drive system of claim 17 wherein the power module includes a housing having an interior for receiving the AC drive therein, the AC drive having an input connectable to a power source and an output connectable to the AC motor.

19. The drive system of claim 17 wherein the interface module includes:
a housing having an interior for receiving the control circuit; and
a user interface for allowing a user to program the control circuit.

20. The drive system of claim 17 further comprising an intermediate module disposed between and interconnecting the power module and the interface module.

21. The drive system of claim 20 wherein the intermediate module includes:
a housing having an interior; and
a bypass circuit received with the interior of the housing and being connected in parallel with the AC drive, the bypass circuit interconnecting the AC motor to the power source in response to failure of the AC drive.

22. The drive system of claim 20 wherein the intermediate module includes:
a housing having an interior; and
a disconnect circuit received with the interior of the housing and being connectable in series with the AC drive, the disconnect circuit disconnecting the AC drive from the power source in response to a predetermined condition.

23. The drive system of claim 17 further comprising a redundant power supply operatively connected to the control circuit for supplying electrical power to the control circuit.
